(19) United States
(12) Patent Application Publication
(10) Pub. No.: US 2018/0294702 A1
(43) Pub. Date: Oct. 11, 2018

(54) MECHANISM AND METHOD FOR INTRODUCING A WAVE WINDING FROM A PREFABRICATED WAVE WINDING MAT INTO STATOR SHEET METAL PACKET GROOVES

(71) Applicant: Aumann Espelkamp GmbH, Espelkamp (DE)

(72) Inventor: Wolfgang Lüttge, Hameln (DE)

(73) Assignee: Aumann Espelkamp GmbH, Espelkamp (DE)

(21) Appl. No.: 15/766,463

(22) PCT Filed: Dec. 15, 2016
(86) PCT No.: PCT/EP2016/081110

§ 371 Date: Apr. 6, 2018

(30) Foreign Application Priority Data
Dec. 18, 2015 (EP) 15201154.0

(51) Int. Cl. H02K 15/06; H02K 15/04; H02K 1/16; H02K 15/02; H02K 1/26; H02K 3/12

(52) U.S. Cl. CPC H02K 15/066; H02K 15/0435; H02K 3/12; H02K 15/024; H02K 1/26; H02K 1/16

(57) ABSTRACT

A mechanism for introducing a wave winding from a prefabricated wave winding mat into a rotor- or stator body having a receiving device for receiving and holding the rotor- or stator body, and a feed device that feeds the wave winding mat to the receiving device. The receiving device further has an introduction device that can isolate the windings of the winding mat and introduce the same in the depth direction R of the grooves into the rotor or stator body.

### CROSS-REFERENCE TO RELATED APPLICATIONS

This patent application is the US national phase of International Application No. PCT/EP2016/081110 having an international filing date of 15 Dec. 2016, which claims priority on and the benefit of European Patent Application No. 15210054.0 having a filing date of 18 Dec. 2015.

### BACKGROUND OF THE INVENTION

### Technical Field

The invention relates to a mechanism for introducing a wave winding from a prefabricated wave winding mat into stator sheet metal packet grooves, and to a method for producing a stator.

### Prior Art

Wave windings are windings, mostly of one or more wires, and particularly but not exclusively of flat wires and/or profiled wires, which have a characteristic wave shape. Wires in the context of the present application are strand-shaped, windable products which are suitable for conducting electric current—in particular those which are made of metal or metal alloys. These are made by alternately winding the wire around a winding blade bending the wire. This process results in wire mats or winding mats which subsequently have to be attached to a rotor or stator body, in particular a rotor or stator sheet metal packet. In this case, each of a defined number of windings must be placed in a groove in the rotor or stator body. According to the prior art, this is hardly automatable. The approach of winding the wave winding mat around a radially expandable introduction device, then placing the same in the ring of the rotor or stator body and pressing the annularly arranged wave winding mat by radial expansion into the inner grooves of the rotor or stator body is known. For this purpose, it must be ensured that the expansion takes place uniformly, which is due to the fact that a radial pressure on a winding inside the wave winding mat consisting of many continuous windings can lead not only to a yielding movement of the corresponding winding, but also to a displacement of the windings of the entire wave winding mat. Thus, the depicted approach requires high precision; and corresponding introduction devices must generally be reconstructed for each length of wave winding mat.

### BRIEF SUMMARY OF THE INVENTION

The object of the present invention is to provide a mechanism for introducing a wave winding from a prefabricated wave winding mat into a rotor- or stator body, and to provide a corresponding method, for producing a rotor or stator, by means of which the introduction of wave winding mats into the grooves can be performed regardless of the length of the wave winding mats, and also reliably and accurately.

This object is achieved by a mechanism for introducing a wave winding from a prefabricated wave winding mat into a rotor- or stator body, having a receiving device for receiving and holding the rotor- or stator body in a fastening position, and a feed device which feeds the wave winding mat to the receiving device, wherein the receiving device further has an introduction device which is designed to isolate windings of the wave winding mat and to introduce the same in a groove depth direction (R), relative to the rotor- or stator body, into grooves of the rotor- or stator body, and by a method for producing a rotor or stator by introducing windings of a wave winding mat into the grooves of a rotor- or stator body, in particular using a mechanism according to the invention, wherein the method has the following steps:
furnishing a rotor- or stator body with grooves formed as recesses on its inside or outside, having a groove depth direction (R) and a groove longitudinal direction (X);
moving a wave winding mat toward the side of the rotor- or stator body equipped with grooves; and
successively introducing windings, by
a) isolating a winding or a plurality of windings,
b) subsequently introducing the winding or the plurality of windings into a groove via an introduction device,
c) after introduction of the winding(s) into a groove, rotating the rotor- or stator body and the introduction device relative to each other, and
d) carrying out steps a), b), and c) again.
   Advantageous embodiments are given in each of the dependent claims.

The mechanism according to the invention for introducing a wave winding from a prefabricated wave winding mat into a rotor- or stator body comprises a receiving device for receiving and holding the rotor- or stator body in a fastening position, and a feed device which feeds the wave winding mat to the receiving device. The receiving device further comprises an introduction device which is designed to isolate windings or groups of windings of the wave winding mat and to introduce windings or groups of windings in a groove depth direction, relative to the rotor- or stator body, into grooves of the rotor- or stator body successively, groove by groove. The groove depth direction is the direction in which the groove extends into the rotor- or stator body. This may be the radial direction, but it can also be grooves arranged in the rotor- or stator body at an angle to the radial direction. In this case, the groove depth direction describes the direction which runs at said angle with respect to the radial direction.

According to the invention, the rotor- or stator body can be designed as a rotor- or stator sheet metal packet, but this is not absolutely necessary. It is also possible to use rotor- or stator bodies made of non-packeted materials—for example, of sintered materials.

According to the method according to the invention, this can be done as follows, in particular using the mechanism according to the invention described above and also below:

First, a rotor- or stator body is furnished with grooves formed on its inside or outside as recesses. The grooves have a groove depth direction which does not necessarily run in the radial direction, and a groove longitudinal direction. The following steps are carried out:
moving a wave winding mat toward the side of the rotor- or stator body which has grooves;
successively introducing windings, by
a) isolating a winding or a plurality of windings,
b) subsequently introducing the winding or the plurality of windings into a groove via an introduction device,
c) after introduction of the winding(s) into a groove, rotating the rotor- or stator body and the introduction device relative to each other, and
d) carrying out steps a), b), and c) again.

The wave winding mat is formed of a wire which is preferably a flat or profiled wire.

The grooves filled with windings can subsequently be closed off with slot closures. For this purpose, the mechanism according to the invention can have a slot closure introduction device which is designed to close a groove filled with windings with a slot closure in the axial direction of the groove and/or the longitudinal direction of the groove.

The successive introduction of the windings groove by groove makes it possible to carry out the process with high precision; in addition, the risk of missing a groove is reduced. Furthermore, the invention works equally well for external and internal grooves in the stator sheet metal packet, and is independent of the length of the wave winding mat being introduced.

The receiving device is preferably designed to be rotatable such that it can rotate the rotor- or stator body in a direction of rotation about the longitudinal axis of the rotor- or stator body. Of course, it is only important that a relative rotation takes place between the rotor- or stator body and the introduction device. Consequently, the receiving device can be fixed and the introduction device can be mounted to rotate relative thereto. For the rotation of the rotor- or stator body, a servomotor can particularly be provided.

According to a preferred embodiment of the invention, the introduction device has an isolating slide which can be advanced in an advancing direction toward the rotor- or stator body. The advancing direction in this case particularly runs at an angle relative to the groove depth direction which is not 0°. In this way, the isolating slide always engages at an incline relative to the introduction direction of the windings, which facilitates the isolation in the manner of a peeling process.

Furthermore, the introduction device can have a groove depth slide, in particular a radial slide. This slide is designed to advance in the groove depth direction toward the rotor- or stator body. In this way, it can push the isolated windings into a groove of the rotor- or stator body by advancing in the groove depth direction.

In order to facilitate the introduction of individual windings or groups of windings, the introduction device can particularly have a guide device which can be positioned over the lateral edges of the rotor- or stator body groove which will be filled with windings.

It is particularly advantageous if the guide device comprises two sheet metal guide plates which will be positioned laterally of the groove which will be filled. The windings can slide along these sheet metal guide plates into the groove which will be filled. In particular, the sheet metal guide plates, which can preferably be made of spring steel, another metal, or plastic, can be positioned in such a manner that contact with sharp-edged groove borders, and thus damage to individual sections of the wave winding mat, is prevented.

Furthermore, according to one embodiment, as an alternative or in addition thereto, the introduction device can have a positioning device. This is designed to position the introduction device over a rotor- or stator body groove which will be filled. In this way, the introduction device is always at a point where an isolated winding or winding group is located directly above the groove which will be filled. Advantageously, the positioning device can be a further slide which may plunge into a groove which will not be filled, preferably into a groove which will be filled later in the filling sequence and is adjacent to the groove which will be filled, and thereby position the introduction device relative to the rotor- or stator body. As such, the filling of the respective groove in the rotor- or stator body can be performed effectively and reliably.

### BRIEF DESCRIPTION OF THE DRAWINGS

The invention is explained in more detail below with reference to FIGS. 1 and 2.

FIG. 1 shows an exemplary mechanism according to the invention, in perspective view.

FIG. 2 shows a view of a rotor- or stator body in the region of the introduction device.

### DETAILED DESCRIPTION OF PREFERRED EMBODIMENTS

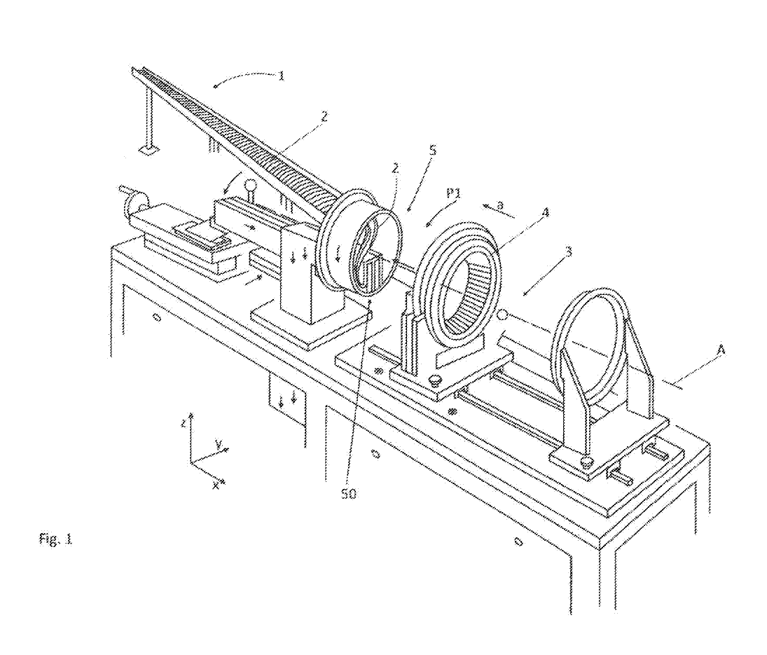

A feed device 1 via which a wave winding mat (also referred to below as mat) 2 is fed to the rotor- or stator body 4 is included in the mechanism shown in FIG. 1. The given illustration shows a receiving device 5, onto which the rotor- or stator body 4 can be pushed (in particular by the transfer device 3 in this case), then fixed on the receiving device 5. After fixing on the receiving device 5, the particularly annular or disk-shaped rotor- or stator body can be rotated about the machine axis A in a rotational direction P1. This is preferably done via a rotary drive, not shown in detail, in particular a servomotor.

The introduction device 50 is arranged on the receiving device 5; it can also be arranged separately therefrom. The given example shows an internally grooved rotor- or stator body 4 (shown particularly as a stator body in this case); however, the mechanism, and most of all the method according to the invention, can also be used with externally grooved rotor- or stator bodies. In this case, the introduction device 50 would not be included on the inner edge of the rotor- or stator body 4 (as shown), but on the corresponding outer edge. The direction a marks the groove longitudinal direction of the grooves, which preferably, but not necessarily, runs parallel to the direction X of the machine axis A.

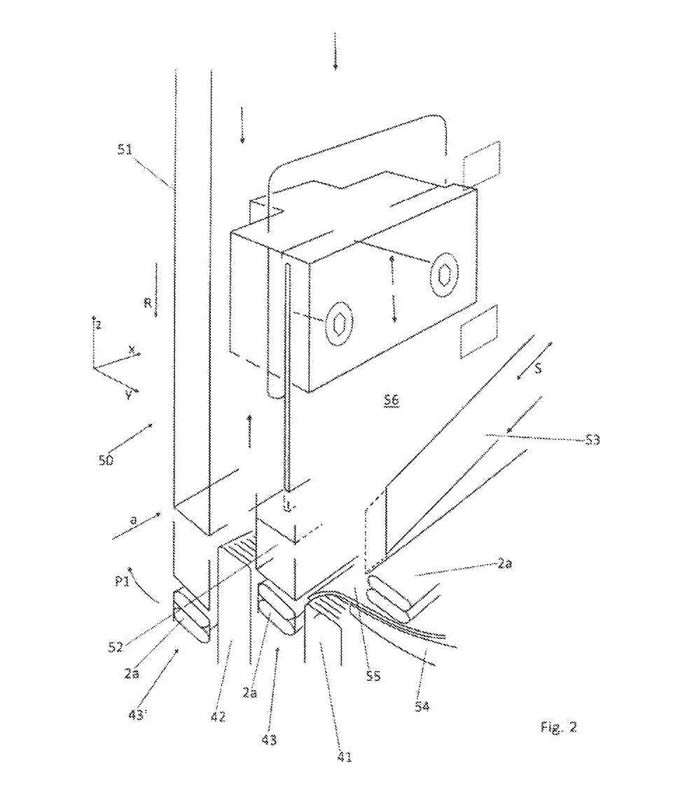

The introduction process illustrated schematically in FIG. 2, for introducing windings 2a of the mat 2, consequently applies to rotor- or stator bodies 4 with inside and outside grooves 43. The grooves 43 of the rotor- or stator body 4 are constructed between groove walls 41, 42. Between two adjacent walls 41, 42, a groove 43 runs in the groove depth direction R (this can be the radial direction of the rotor- or stator body, but need not necessarily be) and in the groove longitudinal direction a, which is preferably parallel to the direction X of the machine axis. In the example shown, the rotor- or stator body can be rotated in direction P1 about the machine axis A.

In the example shown, the mat 2 has two superimposed windings 2a, but can also have more or fewer windings 2a. In particular, the mat can consist of only one layer of windings. The introduction of the windings 2a by means of the introduction device 50 is illustrated here by way of example. The introduction process is shown at a point in time when two windings are introduced into the groove 43. Windings 2a have already been introduced in the groove 43′ traveling ahead in the direction of arrow P1.

The introduction device 50 initially isolates, via an isolating device 53, the windings or winding group 2a which will be introduced at this point from the remaining, not yet introduced windings 2a of the mat. For this purpose, the isolating device is preferably designed to be able to advance in the direction of the rotor- or stator body—in the illustrated example, as a slide 53 with a sliding direction S running at an angle to the groove depth direction R. The approach of the slide in direction S toward the rotor- or stator body holds back the windings 2a which will not yet be introduced, such that they cannot move to a position over the groove 43 which will be filled. Only the windings which will be introduced into the groove 43 are above the groove opening at this point in time. So that they can be introduced into the groove 43 in the groove depth direction R, the introduction device 50 has an element which can (also) be moved in the groove depth direction R, in particular a groove depth slide 52, which presses the winding 2a into the groove 43 after the isolation process. This process is repeated until all windings of the mat are introduced into grooves.

To facilitate the introduction, two aids can be provided as an alternative or as a supplement to each other.

On the one hand, the insertion of the isolated windings 2a can be facilitated with guide elements 54, 55, 56. The guide elements are usually sheet metal guide plates 55 and 56 which are placed in the region of the groove borders so that the windings 2a are not damaged on the sharp-edged borders 41, 42 when they slide into the groove 43. There is preferably a sheet metal guide plate 56 which can be advanced in the groove depth direction, and a further sheet metal guide plate 55 which runs obliquely or along a curve, and which is supported on a wedge element 54 arranged on the introduction device 50 so that a manner of hopper feed is created in which the winding slides over the sheet metal plate 55 and meets the sheet metal plate 56, such that the winding 2a is guided precisely into the groove 43 which will be filled, where it can then be pressed into the groove 43 by the element 52.

A positioning device 51 can be provided as the second mentioned aid. This has the purpose of positioning the introduction device 50, in particular the element 52, precisely above the groove 43 which will be filled. This can occur in such a manner that the positioning device 51 is included as a further groove depth slide arranged on the introduction device 50, which engages in one of the grooves which will be filled, preferably the leading groove 43′, and thereby ensures a defined position of the introduction device before the isolation process and the introduction of the winding 2a into the groove 43.

The mechanism described and the method described are able to simplify and automate the introduction of wave winding mats 2 into rotor- or stator bodies 4.

1. A mechanism for introducing a wave winding from a prefabricated wave winding mat (2) into a rotor- or stator body (4), comprising:
a receiving device (5) for receiving and holding the rotor- or stator body (4) in a fastening position; and
a feed device (1) which feeds the wave winding mat (2) to the receiving device (4),
wherein the receiving device (5) further comprises an introduction device which is designed to isolate windings (2a) of the wave winding mat (2) and to introduce the same in a groove depth direction (R), relative to the rotor- or stator body, into grooves (43) of the rotor- or stator body (4).

2. The mechanism according to claim 1,
wherein the receiving device (5) is rotatable such that the receiving device (5) rotates the rotor- or stator body (4) in a direction of rotation (P1) about a longitudinal axis of the rotor- or stator body (4).

3. The mechanism according to claim 1,
further comprising a servomotor for rotating the rotor- or stator body (4).

4. The mechanism according to
claim 1, wherein the introduction device further comprises an isolating slide (53) which can be advanced toward a stator sheet metal packet in an advancing direction (S) which particularly runs at an angle to the groove depth direction (R) which is not 0°.

5. The mechanism according to
claim 1, wherein the introduction device further comprises a groove depth slide, in particular a radial slide (52), which can be advanced in the groove depth direction (R) to the rotor- or stator body (4), and which is designed to push the isolated windings (2a) into a groove (43) of the rotor- or stator body (4) by advancing in the groove depth direction (R).

6. The mechanism according to
claim 1, wherein the introduction device further comprises a guide device (55, 56) which can be positioned over lateral edges (42) of the rotor- or stator body groove (43) which will be filled with windings, facilitating the introduction of the windings (2a) into the corresponding groove (43).

7. The mechanism according to claim 6,
wherein the guide device comprises two sheet metal guide plates (55, 56) to be positioned in the region of the groove (43) which will be filled, in particular laterally of the groove (43) which will be filled.

8. The mechanism according to
claim 1, further comprising a positioning device (51) which is designed to position the introduction device over a groove (43) of the rotor- or stator body (4) which will be filled.

9. The mechanism according to
claim 1, further comprising a slot closure introduction device which is designed to close with a slot closure, in the axial direction of the groove (43) filled with windings.

10. The mechanism according to
claim 1, wherein the groove depth direction (R) is the radial direction of the rotor- or stator body (4).

11. The mechanism according to
wherein the rotor- or stator body (4) is a rotor- or stator sheet metal packet, in particular as a stator sheet metal packet.

12. A method for producing a stator by introducing windings (2a) of a wave winding mat (2) into the grooves (43) of a rotor- or stator body (4), in particular using a mechanism according to claim 1, wherein the method comprises the following steps:
furnishing a rotor- or stator body (4) with grooves (43, 43*) formed as recesses on an inside or outside of the rotor- or stator body (4), having a groove depth direction (R) and a groove longitudinal direction (X);
moving a wave winding mat (2) toward the side of the rotor- or stator body (4) equipped with grooves (43); and
successively introducing windings, by
a) isolating a winding (2a) or a plurality of windings (2a),
b) subsequently introducing the winding (2a) or the plurality of windings (2a) into a groove (43) via an introduction device (5),
c) after introduction of the winding(s) (2a) into a groove (43), rotating the rotor- or stator body (4) and the introduction device (5) relative to each other, and
d) carrying out steps a), b), and c) again.

13. The method according to claim 12,
further comprising finally closing off the grooves (43) filled with windings (2a) with slot closures.

14. The method according to claim 12,
further comprising using a rotor- or stator sheet metal packet, in particular a stator sheet metal packet, as the rotor- or stator body (4).

15. The method according to claim 13, further comprising using a rotor- or stator sheet metal packet, in particular a stator sheet metal packet, as the rotor- or stator body (4).
